(19) United States
(12) Patent Application Publication
(10) Pub. No.: US 2026/0025266 A1
(43) Pub. Date: Jan. 22, 2026

(54) ELECTRONIC APPARATUS AND CONTROL METHOD THEREOF

(71) Applicant: CRYPTO LAB INC., Seoul (KR)

(72) Inventors: Jai Hyun Park, Lyon (FR); Damien Stehle, Seoul (KR)

(21) Appl. No.: 19/270,801

(22) Filed: Jul. 16, 2025

(30) Foreign Application Priority Data
Jul. 16, 2024 (KR) 10-2024-0093468
Jul. 11, 2025 (KR) 10-2025-0094049

(51) Int. Cl. H04L 9/08; H04L 9/00

(52) U.S. Cl. CPC H04L 9/0869; H04L 9/008

(57) ABSTRACT

Disclosed is an electronic apparatus. The apparatus includes: a memory storing instructions; a communication interface; and at least one processor including processing circuitry, wherein the at least one processor is configured to obtain a ciphertext by using a learning-with-error (LWE)-based encryption scheme or an exact Cheon-Kim-Kim-Song (CKKS)-based encryption scheme, and control the communication interface to transmit, to a server, a seed for generating a random vector included in the ciphertext and upper bits of an integer included in the ciphertext.

### TECHNICAL FIELD

The present disclosure relates to an electronic apparatus and a control method thereof, and more particularly, to an electronic apparatus for reducing data transmitted to a server and a control method thereof.

### BACKGROUND ART

With the development of electronic technology, various types of electronic apparatus have been developed. In particular, in recent years, encryption and decryption technologies for information security have been developed along with the development of most communication technologies.

If a message encrypted by encryption technology is transmitted to a counterpart, the counterpart is required to perform decryption to use the message. In this case, a waste of resources and time may occur in a process of decrypting the encrypted data. In addition, a decrypted message may be hacked while the decrypted message is temporarily present for computation.

To solve such problems, homomorphic encryption (HE) has been studied. According to the homomorphic encryption (HE), even if a computation is performed on a ciphertext itself without decrypting the encrypted information, the same result as encrypting a plaintext after operating the plaintext may be obtained. That is, according to the homomorphic encryption, various computations may be performed on a ciphertext without decrypting the ciphertext.

However, the homomorphic ciphertext has a very large capacity to occupy a substantial transmission bandwidth, and may cause communication delay and increase a client load, which may eventually cause a risk of ciphertext inconsistency.

### DISCLOSURE OF INVENTION

### Solution to Problem

According to an embodiment of the present disclosure, provided is an electronic apparatus including: a memory storing instructions; a communication interface; and at least one processor including processing circuitry, wherein the at least one processor is configured to obtain a ciphertext by using a learning-with-error (LWE)-based encryption scheme or an exact Cheon-Kim-Kim-Song (CKKS)-based encryption scheme, and control the communication interface to transmit, to a server, a seed for generating a random vector included in the ciphertext and upper bits of an integer included in the ciphertext.

The at least one processor may be configured to obtain the random vector from the seed by using an extendable output function (XOF), the extendable output function including a Secure Hash Algorithm Keccak (SHAKE) function.

The at least one processor may be configured to generate a plurality of random vectors by using one seed and a counter if a plurality of ciphertexts are transmitted.

The at least one processor may be configured to compute the random vector and a secret key, and obtain the integer based on a computation result and a plaintext corresponding to the ciphertext.

The at least one processor may be configured to control the communication interface to transmit, to the server, the upper bits of the integer in a form of └(2^{\hat{p}}/Δ)·b┐, where b indicates the integer, and \hat{p} indicates an input precision.

└(2^{\hat{p}}/Δ)·b┐ may be rescaled into Δ/2^{\hat{p}} by the server and used.

The integer indicates a remainder obtained by dividing a plaintext corresponding to the ciphertext by a modulus.

The LWE-based encryption scheme may include either a Torus Fully Homomorphic Encryption (TFHE) scheme or a Fastest Homomorphic Encryption in the West (FHEW) scheme.

The seed may be converted into the random vector by the server.

According to an embodiment of the present disclosure, provided is a control method of an electronic apparatus, the method including: obtaining a ciphertext by using a learning-with-error (LWE)-based encryption scheme or an exact Cheon-Kim-Kim-Song (CKKS)-based encryption scheme; and transmitting, to a server, a seed for generating a random vector included in the ciphertext and upper bits of an integer included in the ciphertext.

In the obtaining, the random vector may be obtained from the seed by using an extendable output function (XOF), the extendable output function including a Secure Hash Algorithm Keccak (SHAKE) function.

In the obtaining, a plurality of random vectors may be generated by using one seed and a counter if a plurality of ciphertexts are transmitted.

In the obtaining, the random vector and a secret key may be computed, and the integer may be obtained based on a computation result and a plaintext corresponding to the ciphertext.

In the transmitting, the upper bits of the integer in a form of └(2^{\hat{p}}/Δ)·b┐ may be transmitted to the server, where b indicates the integer, and indicates an input precision.

└(2^{\hat{p}}/Δ)·b┐ may be rescaled into Δ/2^{\hat{p}} by the server and used.

The integer indicates a remainder obtained by dividing a plaintext corresponding to the ciphertext by a modulus.

The LWE-based encryption scheme may include either a Torus Fully Homomorphic Encryption (TFHE) scheme or a Fastest Homomorphic Encryption in the West (FHEW) scheme.

The seed may be converted into the random vector by the server.

### BRIEF DESCRIPTION OF DRAWINGS

FIG. 1 is a diagram illustrating a structure of a network system according to an embodiment of the present disclosure.

FIG. 2 is a diagram illustrating a structure of a network system according to an embodiment of the present disclosure.

FIG. 3 is a block diagram showing a configuration of an electronic apparatus according to an embodiment of the present disclosure.

FIGS. 4 and 5 are diagrams illustrating a method for reducing a communication cost according to an embodiment of the present disclosure.

FIG. 6 is a flowchart illustrating a control method of an electronic apparatus according to an embodiment of the present disclosure.

### MODE FOR INVENTION

Hereinafter, embodiments of the present disclosure are described in detail with reference to the accompanying drawings.

General terms currently widely used are selected as terms used in embodiments of the present disclosure in consideration of their functions in the present disclosure, and may be changed based on the intentions of those skilled in the art or a judicial precedent, the emergence of a new technique, or the like. In addition, in a specific case, terms arbitrarily selected by an applicant may be present. In this case, the meanings of such terms are mentioned in detail in corresponding descriptions of the present disclosure. Therefore, the terms used in the present disclosure need to be defined on the basis of the meanings of the terms and the contents throughout the present disclosure rather than simple names of the terms.

In the specification, the expression such as “have”, “may have”, “include”, or “may include”, indicates the presence of a corresponding feature (for example, a numerical value, a function, an operation, or a component such as a part), and does not exclude the presence of an additional feature.

An expression such as “at least one of A or/and B” may indicate either “A or B”, or “both of A and B.”

Expressions such as “first” and “second”, used in the present disclosure may indicate various components regardless of the sequence or importance of the components. The expression is used only to distinguish one component from another component, and does not limit the corresponding component.

A term of a singular number may include its plural number unless explicitly indicated otherwise in the context. It should be understood that a term “include” or “have” used in this application specifies the presence of features, numerals, steps, operations, components, parts, or combinations thereof, which are mentioned in the specification, and does not preclude the presence or addition of one or more other features, numerals, steps, operations, components, parts, or combinations thereof.

In the specification, such a term as a “user” may refer to a person who uses an electronic apparatus or an apparatus (for example, an artificial intelligence electronic apparatus) which uses the electronic apparatus.

Hereinafter, various embodiments according to the present disclosure are described in more detail with reference to the accompanying drawings.

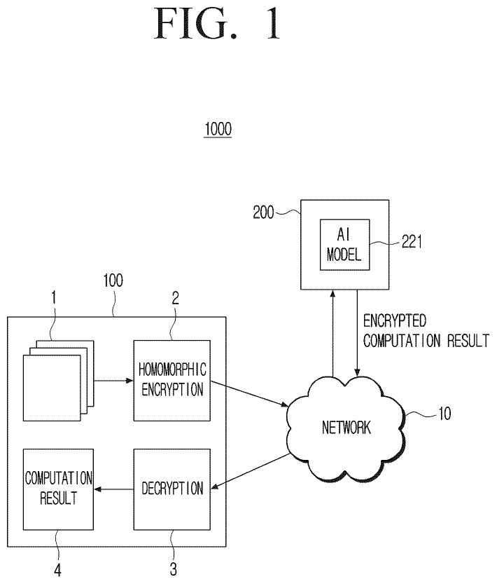

FIG. 1 is a diagram illustrating a structure of a network system 1000 according to an embodiment of the present disclosure.

Referring to FIG. 1, an electronic apparatus 100 and a server 200 may communicate with each other through a network 10. The network 10 may be implemented as any of various types of wired or wireless communication networks, broadcast communication networks, optical communication networks, cloud networks, or the like, and the respective apparatuses may also be connected to each other by a method such as wireless-fidelity (Wi-Fi), Bluetooth, or near field communication (NFC) without any separate medium.

FIG. 1 illustrates one electronic apparatus 100. However, the electronic apparatus 100 may be implemented in a number of various types. For example, the electronic apparatus 100 may be a smartphone, a tablet, a personal computer (PC), a laptop PC, a home server, a kiosk, a game player, or a camera. In addition, the electronic apparatus 100 may also be implemented as a home appliance to which an internet of things (IoT) function is applied.

For example, if the electronic apparatus 100 includes a camera, the electronic apparatus 100 may directly capture and obtain at least one original data 1. If the electronic apparatus 100 includes no camera, the electronic apparatus 100 may receive the original data 1 from an external device (e.g., a camera or a memory stick) through various wired or wireless interfaces and store the same. In various embodiments of the present disclosure, the original data 1 may be a photograph image, is not limited thereto, and may be a graphic image. Alternatively, the original data 1 may be video content including a plurality of image frames.

The electronic apparatus 100 may perform homomorphic encryption 2 on at least one original data to obtain a homomorphic ciphertext, and then transmit the homomorphic ciphertext to the server 200 through the network 10.

In this case, in a process of transmitting the original data 1, the original data 1 may be hacked and leaked to the outside or leaked by an administrator of the server 200. However, if the original data is transmitted in the form of homomorphic ciphertext, the original data is incapable of being identified even if the original data 1 is leaked to the outside. Therefore, security for the personal information or physical characteristics of a user may be enhanced.

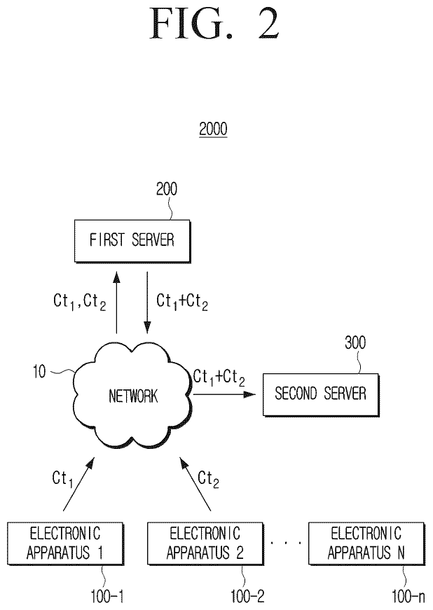

Although various homomorphic encryption algorithms are possible for generating the homomorphic ciphertext, various embodiments in FIGS. 1 and 2 describe a case where the homomorphic encryption is performed using a Cheon-Kim-Kim-Song (CKKS) scheme or a modified algorithm based thereon to assist in the understanding of the present disclosure.

The electronic apparatus 100 may perform encoding to transmit the original data in the form of homomorphic ciphertext. In the homomorphic encryption, encoding may refer to a process for converting data into an encryptable format. The homomorphic encryption is performed based on a mathematical structure (e.g., polynomial computation), and accordingly, the original data 1 may be converted into a form processable by the homomorphic encryption algorithm and then homomorphic encryption may be performed thereon.

In the homomorphic encryption, a slot encoding method and a coefficient encoding method may generally be used.

The slot encoding method may allocate data to be encrypted to a plurality of slots and then encode the data in units of entire slots. A slot refers to a unit of data that may be stored in parallel in one homomorphic ciphertext. If the ciphertext is expressed in the form of a polynomial, coefficients or roots of the polynomial may serve as each slot. If one ciphertext includes a total of n slots, n values may be simultaneously encoded or operated. That is, if the slot encoding is performed, parallel computations on the homomorphic ciphertext may be performed. The slot encoding method may vary depending on the homomorphic encryption algorithm. The above-described CKKS scheme may perform the slot encoding by using a Fast Fourier transform (FFT).

The coefficient encoding method may convert data to be encrypted into a polynomial form and convert coefficients of the polynomial into encrypted values. The above-described CKKS scheme may perform the coefficient encoding by using a Discrete Fourier Transform (DFT).

The server 200 is a device for performing computations on the homomorphic ciphertext in a homomorphically encrypted state (i.e., at least one original data encrypted using the homomorphic encryption) provided from the electronic apparatus 100, and for providing an encrypted computation result. The server 200 may be implemented in any of various forms such as a web server or a cloud server.

An artificial intelligence (AI) model 221 for performing computation on a ciphertext in the encrypted state may be stored in the server 200.

As described above, if the AI model 221 receives the original data and is to perform the computation on the received original data, the AI model 221 may be configured as a convolutional neural network (CNN), and is not necessarily limited thereto.

In detail, the AI model 221 may perform various computations on a homomorphic ciphertext encrypted using a homomorphic encryption technology (e.g., the CKKS scheme), and output a computation result in the form of homomorphic ciphertext. Hereinafter, the computation result output in the form of homomorphic ciphertext is referred to as an encrypted computation result.

If the AI model 221 is configured as the CNN, the AI model 221 of the server 200 may perform depth-wise convolution computations or convolution computations on the homomorphic ciphertext transmitted from the electronic apparatus 100 by using model parameters. Such a computation method is described in detail in the following description.

The server 200 may transmit the encrypted computation result to the electronic apparatus 100 through the network 10. The electronic apparatus 100 may perform decryption 3 on the received encrypted computation result and provide a computation result 4 to the user. A method for providing the result may vary depending on the type and configuration of the electronic apparatus 100.

For example, if the electronic apparatus 100 includes a display or is connected to an external display (e.g., a monitor), the electronic apparatus 100 may display the decrypted computation result 4.

For example, if the electronic apparatus 100 includes a speaker, the electronic apparatus 100 may output a voice message corresponding to the computation result through the speaker.

For example, if the electronic apparatus 100 communicates with another terminal device (e.g., a smartphone), the electronic apparatus 100 may transmit the decrypted computation result to the terminal device.

For example, if the AI model 221 is a model trained to diagnose disease, the computation result may include information on the presence or absence of a disease, a type of disease, a progress of the disease, or the like based on the original data 1 of the user.

FIG. 2 is a diagram illustrating a structure of a network system 2000 according to an embodiment of the present disclosure.

Referring to FIG. 2, the network system may include a plurality of electronic apparatuses 100-1 to 100-n, a first server 200, and a second server 300, and the respective components may be connected to each other through the network 10.

The network 10 may be implemented as any of various types of wired or wireless communication networks, broadcast communication networks, optical communication networks, or cloud networks, and the respective apparatuses may also be connected to each other by a method such as Wi-Fi, Bluetooth, or near field communication (NFC) without any separate medium.

FIG. 2 illustrates that the plurality of electronic apparatuses 100-1 to 100-n are provided. However, the plurality of electronic apparatuses are not necessarily used, and one apparatus may also be used. For example, each of the electronic apparatuses 100-1 to 100-n may be implemented as various types of devices such as a smartphone, a tablet, a game player, a PC, a laptop PC, a home server, or a kiosk. In addition, the electronic apparatus may also be implemented in the form of a home appliance to which the IoT function is applied.

The user may input various information through the electronic apparatuses 100-1 to 100-n used by the user. The input information may be stored in the electronic apparatuses 100-1 to 100-n themselves. However, for reasons such as storage capacity and security, the input information may also be transmitted to the external device and stored therein. As illustrated in FIG. 2, the first server 200 may serve to store such information, and the second server 300 may serve to use part or all of the information stored in the first server 200.

Each of the electronic apparatuses 100-1 to 100-n may perform the homomorphic encryption on the input information and transmit the homomorphic ciphertext to the first server 200.

Each of the electronic apparatuses 100-1 to 100-n may include encryption noise, that is, error, occurring in the process of performing the homomorphic encryption, in the ciphertext. In detail, the homomorphic ciphertext generated by each of the electronic apparatuses 100-1 to 100-n may be generated in a form for restoring a result value including a message and an error value if decrypted at a subsequent time using a secret key.

For example, the homomorphic ciphertext generated by the electronic apparatuses 100-1 to 100-n may be generated in a form satisfying the following property if decrypted using the secret key.

Dec(ct,sk)=<ct,sk>=M+e(mod q) [Equation 1]

Here, <, > denotes an inner product computation (i.e., a usual inner product), ct denotes a ciphertext, sk denotes a secret key, M denotes a plaintext message, e denotes an encryption error value, and mod q denotes a ciphertext modulus. q needs to be selected to be greater than a result value M obtained by multiplying a scaling factor Δ by the message. If an absolute value of an error value e is sufficiently smaller than M, a decrypted value M+e of the ciphertext may be a value that may replace an original message by the same precision in a significant figure computation. In the decrypted data, the error may be disposed on the least significant bit (LSB), and M may be disposed on the next least significant bit.

If a message size is too small or too large, the size may be adjusted using the scaling factor. If the scaling factor is used, not only an integer-type message but also a real-number-type message may be encrypted, and its usability may thus be greatly increased. In addition, the message size may be adjusted using the scaling factor to thus also adjust a size of an effective region, that is, a region where the messages are present in the ciphertext after the computation is performed.

According to an embodiment, the ciphertext modulus q may be set and used in various forms. For example, the ciphertext modulus may be set in a form of an exponential power q=Δ^{L} of the scaling factor Δ. If Δ is 2, the modulus may be set to a value such as q=2¹⁰.

In addition, the homomorphic ciphertext according to the present disclosure is described assuming that fixed point-numbers are used. However, the homomorphic ciphertext may also be applied even to a case where floating-point numbers are used.

The first server 200 may store the received homomorphic ciphertext in a ciphertext state without decrypting the ciphertext.

The second server 300 may request a specific processing result for the homomorphic ciphertext from the first server 200. The first server 200 may perform a specific computation based on the request from the second server 300 and then transmit its result to the second server 300.

For example, if ciphertexts ct1 and ct2 transmitted from the two electronic apparatuses 100-1 and 100-2 are stored in the first server 200, the second server 300 may request the first server 200 for a value obtained by combining information provided by the two electronic apparatuses 100-1 and 100-2. The first server 200 may perform a computation for combining the two ciphertexts based on the request and then transmit a result value ct1+ct2 to the second server 300.

Due to a property of homomorphic ciphertext, the first server 200 may perform the computation without decrypting the ciphertext, and the result value may also be generated in a ciphertext form. In the present disclosure, the result value obtained by the computation is referred to as a computation result ciphertext.

The first server 200 may transmit the computation result ciphertext to the second server 300. The second server 300 may decrypt the received computation result ciphertext to thus obtain the computation result value of data included in each homomorphic ciphertext.

Accordingly, the electronic apparatus 100 may perform an efficient multiplication computation while minimizing the number of Residual Number System (RNS) moduli, thereby enabling a faster computation on the homomorphic ciphertext.

Meanwhile, FIG. 2 illustrates a case where a first electronic apparatus and a second electronic apparatus perform the encryption and the second server performs the decryption. However, the present disclosure is not necessarily limited thereto.

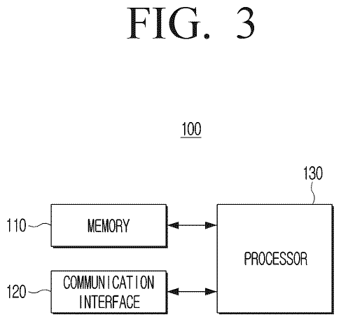

FIG. 3 is a block diagram showing a configuration of the electronic apparatus 100 according to an embodiment of the present disclosure.

Referring to FIG. 3, the electronic apparatus 100 may include a memory 110 storing instructions, a communication interface 120, and at least one processor 130. At least one processor 130 may perform the following operations by executing instructions.

The memory 110 may refer to hardware storing information such as data in an electrical or magnetic form for the processor 130 or the like to access the data. To this end, the memory 110 may be implemented as at least one hardware among a non-volatile memory, a volatile memory, a flash memory, a hard disk drive (HDD), a solid state drive (SSD), a random access memory (RAM), a read only memory (ROM), or the like.

The memory 110 may store at least one instruction necessary for operating the electronic apparatus 100 or the processor 130. Here, the instruction is a code unit indicating the operation of the electronic apparatus 100 or the processor 130, and may be written in a machine language, which is a language that a computer may understand. Alternatively, the memory 110 may store the plurality of instructions for performing a specific task of the electronic apparatus 100 or the processor 130 as an instruction set.

The memory 110 may store data in units of bits or bytes which may represent characters, numbers, images, or the like. For example, the memory 110 may store data to be encrypted or encrypted data.

The memory 110 may be accessed by the processor 130, and the processor 130 may perform the readout, recording, correction, deletion, update, or the like of the instructions, the instruction set, or the data.

The communication interface 120 is a component for performing communication with various types of external devices by using various types of communication methods. For example, the electronic apparatus 100 may communicate with the server 200 through the communication interface 120.

The communication interface 120 may include a Wi-Fi module, a Bluetooth module, an infrared communication module, or a wireless communication module. Here, each communication module may be implemented in a form of at least one hardware chip.

The Wi-Fi module and Bluetooth module may perform the communication in a Wi-Fi manner and a Bluetooth manner, respectively. In case of using the Wi-Fi module or the Bluetooth module, the communication interface may first transmit and receive various connection information such as a service set identifier (SSID) or a session key, and connect the communication based on this connection information, and then transmit and receive various information. The infrared communication module may perform the communication based on infrared data association (IrDA) technology that wirelessly transmits data in a short distance using an infrared ray between visible and millimeter waves.

In addition to the above-described communication manners, the wireless communication module may include at least one communication chip performing the communication based on various wireless communication standards such as Zigbee, third generation (3G), third generation partnership project (3GPP), long term evolution (LTE), LTE advanced (LTE-A), fourth generation (4G), and fifth generation (5G).

Alternatively, the communication interface 120 may include a wired communication interface such as a high definition multimedia interface (HDMI), DisplayPort (DP), Thunderbolt, a universal serial bus (USB), a red-green-blue (RGB) port, a D-subminiature (D-SUB) port, or a digital visual interface (DVI) port.

In addition, the communication interface 120 may include at least one of wired communication modules performing the communication by using a local area network (LAN) module, an Ethernet module, a pair cable, a coaxial cable, or an optical fiber cable.

The processor 130 may control overall operations of the electronic apparatus 100. In detail, the processor 130 may be connected to each component of the electronic apparatus 100 and control the overall operations of the electronic apparatus 100. For example, the processor 130 may be connected to the memory 110, the communication interface 120, or the like, and control the operations of the electronic apparatus 100.

At least one processor 130 may include at least one of a CPU, a graphics processing unit (GPU), an accelerated processing unit (APU), a many integrated core (MIC), a neural processing unit (NPU), a hardware accelerator, or a machine learning accelerator. At least one processor 130 may control one or any combination of other components included in the electronic apparatus 100, and may perform operations relating to communication or data processing. At least one processor 130 may execute at least one program or instruction stored in the memory 110. For example, at least one processor 130 may perform a method according to an embodiment of the present disclosure by executing at least one instruction stored in the memory 110.

If the method according to an embodiment of the present disclosure includes a plurality of operations, the plurality of operations may be performed by one processor, or may be performed by a plurality of processors. For example, if a first operation, a second operation, and a third operation are performed by the method according to an embodiment, the first operation, the second operation, and the third operation may all be performed by a first processor, or the first operation and the second operation may be performed by the first processor (e.g., a general-purpose processor) and the third operation may be performed by a second processor (e.g., an artificial intelligence-specific processor).

At least one processor 130 may be implemented as a single-core processor including a single core, or as at least one multi-core processor including multiple cores (e.g., homogeneous multiple cores or heterogeneous multiple cores). If at least one processor 130 is implemented as the multi-core processor, each of the multiple cores included in the multi-core processor may include an internal memory of the processor, such as a cache memory or an on-chip memory, and a common cache shared by the multiple cores may be included in the multi-core processor. In addition, each of the multiple cores (or some of the multiple cores) included in the multi-core processor may independently read and perform a program instruction for implementing the method according to an embodiment of the present disclosure, or all (or some) of the multiple cores may be linked to read and perform the program instruction for implementing the method according to an embodiment of the present disclosure.

If the method according to an embodiment of the present disclosure includes a plurality of operations, the plurality of operations may be performed by the single core among the multiple cores included in the multi-core processor, or may be performed by the multiple cores. For example, if the first operation, the second operation, and the third operation are performed using the method according to an embodiment, the first operation, the second operation, and the third operation may all be performed by a first core included in the multi-core processor, or the first operation and the second operation may be performed by the first core included in the multi-core processor and the third operation may be performed by a second core included in the multi-core processor.

In the embodiments of the present disclosure, the processor 130 may indicate a system on a chip (SoC) integrating at least one processor and other electronic components, the single-core processor, the multi-core processor, or a core included in the single-core processor or the multi-core processor. Here, the core may be implemented as the CPU, the GPU, the APU, the MIC, the NPU, the hardware accelerator, or the machine learning accelerator. However, an embodiment of the present disclosure is not limited thereto. For convenience of description, the operation of the electronic apparatus 100 is hereinafter described by the term “processor 130.”

The processor 130 may obtain the ciphertext by using a learning-with-error (LWE)-based encryption scheme or an exact CKKS-based encryption scheme, and control the communication interface 120 to transmit, to the server 200, a seed for generating a random vector included in the ciphertext and upper bits of an integer included in the ciphertext. Here, the LWE-based encryption scheme may include either a Torus Fully Homomorphic Encryption (TFHE) scheme or a Fastest Homomorphic Encryption in the West (FHEW) scheme.

The processor 130 may obtain the random vector from the seed by using an extendable output function (XOF). Here, the extendable output function may include a Secure Hash Algorithm Keccak (SHAKE) function.

The seed transmitted to the server 200 may be converted into the random vector by the server 200. For example, the server 200 may obtain the random vector from the seed by using the same method as a method by which the electronic apparatus 100 obtains the random vector from the seed.

That is, the seed having a relatively small capacity may be transmitted to the server 200 rather than the random vector having a relatively large capacity being transmitted to the server 200. A capacity difference is significant, and transmitting the seed may thus be more economical than transmitting the random vector.

In an embodiment, the processor 130 may generate a plurality of random vectors by using one seed and a counter if a plurality of ciphertexts are transmitted.

In an embodiment, the processor 130 may compute the random vector and the secret key, obtain the integer based on a computation result and a plaintext corresponding to the ciphertext, and control the communication interface 120 to transmit the upper bits of the integer to the server 200. Here, the integer indicates a remainder obtained by dividing the plaintext corresponding to the ciphertext by a modulus.

The server 200 does not include the secret key, and accordingly, the server 200 may not obtain the integer even if the server 200 obtains the random vector, and the integer needs to be provided by the electronic apparatus 100. However, in the plaintext, upper bits may be data and lower bits may be an error, and accordingly, only the upper bits of the integer may be significant. That is, the processor 130 may more economically transmit data by transmitting only the upper bits of the integer to the server 200 rather than transmitting the entire integer to the server 200.

The processor 130 may control the communication interface 120 to transmit, to the server, the upper bits of the integer in a form of └(2^{\hat{p}}/Δ)·b┐. Here, b indicates the integer, and \hat{p} indicates an input precision. └(2^{\hat{p}}/Δ)·b┐ may be resealed into Δ/2^{\hat{p}} by the server 200 and used.

As described above, the electronic apparatus 100 may significantly reduce a transmission amount by transmitting, to the server 200, only the seed and the upper bits of the integer.

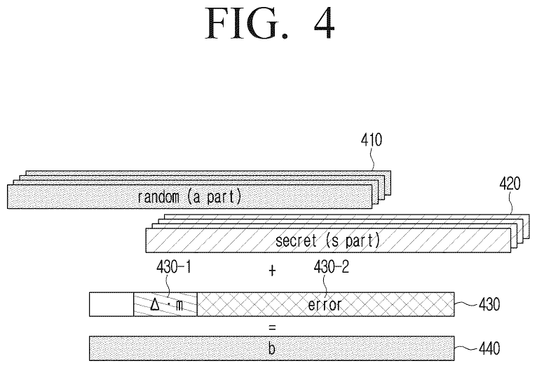

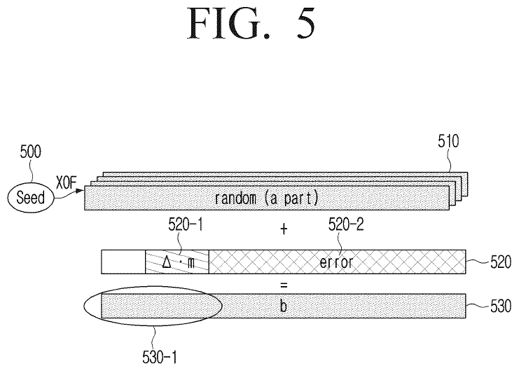

Hereinafter, the operation of the electronic apparatus 100 is described in more detail with reference to FIGS. 4 and 5. For convenience of description, individual embodiments are described with reference to FIGS. 4 and 5. However, the individual embodiments in FIGS. 4 and 5 may be implemented in any combination.

FIGS. 4 and 5 are diagrams illustrating a method for reducing a communication cost according to an embodiment of the present disclosure.

The following description describes a method for reducing the communication cost upon transmitting TFHE, FHEW, and Exact CKKS ciphertexts.

### 1. Transciphering to TFHE and FHEW

The TFHE and FHEW schemes may be performed based on a learning-with-error (LWE) problem. These schemes and their extensions may be configured as ciphertexts in the following form.

$$( \vec{a} , b ) ∈ {ℤ}_{q}^{n + 1}$$

Here, to encrypt a message m∈ [symbol] ₚ by using a secret key \vec{s}, a random vector \vec{a} may be sampled from

$${ℤ}_{q}^{n} ,$$

and b may be set to satisfy the following expression (modulo q):

$$b = 〈 \vec{a} , \vec{s} 〉 + Δ m + \vec{e}$$

Here, \vec{e} may be a small random vector, and this expression may be expressed together with \vec{a} apart 410, an s part 420, a message and error 430, and a b part 440 in FIG. 4. Here, the message and error 430 may include a message 430-1 and an error 430-2.

The processor 130 (i.e., a client) may reduce the communication cost of the LWE-based ciphertext by using the extendable output function and a truncation technique. For example, upon transmitting an LWE-type ciphertext (\vec{a},b) to the server 200, the processor 130 may transmit only the seed and a most significant portion of the b part 440.

### Reduction of the \vec{a} Part

The processor 130 may use the extendable output function (XOF) such as SHAKE for a short seed to reduce the communication cost caused by the \vec{a} part. The processor 130 may generate the \vec{a} part of the ciphertext by applying the XOF to the seed. Subsequently, upon transmitting the TFHE or FHEW ciphertexts, the processor 130 may transmit only the seed (e.g., 128 bits) to the server 200 instead of

$$\vec{a} ∈ {ℤ}_{q}^{n}$$

having a bit size of n·log q. For example, as illustrated in FIG. 5, the processor 130 may transmit only a seed 500 to the server 200 instead of the entire a part 510. The server 200 may restore the \vec{a} part by using the XOF based on the received seed 500.

According to an embodiment, upon transmitting a plurality of ciphertexts, the processor 130 may transmit one seed and the counter together. In this case, the communication cost for seed transmission may be negligible in an amortized manner. In addition, the processor 130 may employ a public seed in a practical application.

Reduction and pre-computation of the b part

To reduce the communication cost caused by the b part, the processor 130 may truncate lower bits of the b part.

For example, the processor 130 may pre-compute \vec{a} and \hat{b}= [symbol] \vec{a},\vec{s} [symbol] mod q by using the secret key \vec{s} and the seed, and may compute b=\hat{b}+m in an online stage. The processor 130 may transmit the following instead of the b part.

$$⌊ ( {2}^{\hat{p}} / Δ ) \cdot b ⌉ = ⌊ ( {2}^{\hat{p}} / Δ ) \cdot ( \hat{b} + m ) ⌉ \approx ( {2}^{\hat{p}} / Δ ) \cdot \hat{b} + ⌊ ( {2}^{\hat{p}} / Δ ) \cdot m ⌉$$

Here, \hat{p} indicates the input precision. The server 200 may multiply the received ciphertext └(2^{\hat{p}}/Δ)·b┐ by Δ/2^{\hat{p}} to obtain an LWE ciphertext for m of sufficient precision ≈\hat{p}. For example, as illustrated in FIG. 5, the processor 130 may transmit only a message 520-1 excluding an error 520-2 to the server 200, instead of transmitting the message and error 520.

FHEW/TFHE bootstrapping has high tolerance for noise, and the number of bits of \hat{b} may thus be very small. If the FHEW/TFHE encrypts a plurality of bits simultaneously (e.g., p>2), a compression ratio may be very high, particularly in functional bootstrapping versions.

Both the processor 130 and the server 200 may pre-compute the XOF, and online computation costs may thus be significantly reduced. In an embodiment, the server 200 may not require bootstrapping before starting the computation.

As described above, the processor 130 may reduce the costs by targeting the LWE-based fully homomorphic encryption schemes. In addition, the processor 130 may focus on the LWE-based schemes to simplify the stages, thereby significantly reducing the computation costs in both offline and online stages. In addition, the LWE-based schemes generally target smaller precision, and an effect of the truncation technique may thus be greater. In addition, the LWE-based schemes encrypt a plaintext in the most significant bits of a ciphertext, and may thus sufficiently operate using a small number of bits.

### 2. Transciphering to Exact CKKS

The above-described transciphering may also be applied to exact variants thereof. In this case, similar to LWE-based schemes, the effect of the truncation technique may be greater. The reason is that the Exact CKKS generally targets smaller precision than an original CKKS scheme, and none of the schemes [3] and [4] uses a gap between the plaintext and the modulus.

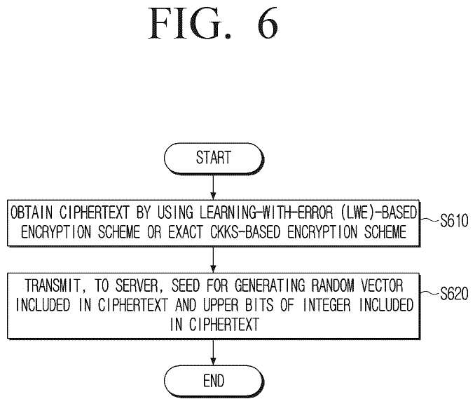

FIG. 6 is a flowchart illustrating a control method of an electronic apparatus according to an embodiment of the present disclosure.

First, the method may include obtaining a ciphertext by using a learning-with-error (LWE)-based encryption scheme or an exact CKKS-based encryption scheme (S610). In addition, the method may include transmitting, to a server, a seed for generating a random vector included in the ciphertext and upper bits of an integer included in the ciphertext (S620).

In addition, in the obtaining (S610), the random vector may be obtained from the seed by using an extendable output function (XOF), and the extendable output function may include a Secure Hash Algorithm Keccak (SHAKE) function.

In addition, in the obtaining (S610), a plurality of random vectors may be generated by using one seed and a counter if a plurality of ciphertexts are transmitted.

In addition, in the obtaining (S610), the random vector and a secret key may be computed, and the integer may be obtained based on a computation result and a plaintext corresponding to the ciphertext.

In addition, in the transmitting (S620), the upper bits of the integer in a form of └(2^{\hat{p}}/Δ)·b┐ may be transmitted to the server, where b indicates the integer, and \hat{p} indicates the input precision.

In addition, └(2^{\hat{p}}/Δ)·b┐ may be rescaled into Δ/2^{\hat{p}} by the server and used.

In addition, the integer indicates a remainder obtained by dividing a plaintext corresponding to the ciphertext by a modulus.

In addition, the LWE-based encryption scheme may include either a Torus Fully Homomorphic Encryption (TFHE) scheme or a Fastest Homomorphic Encryption in the West (FHEW) scheme.

In addition, the seed may be converted into the random vector by the server.

### REFERENCES

[1] R. Avanzi, J. Bos, L. Ducas, E. Kiltz, T. Lepoint, V. Lyubashevsky, J. M. Schanck, P. Schwabe, G. Seiler, and D. Stehlé. Algorithm Specifications And Supporting Documentation. Available at https://www.pq-crystals.org/kyber.
[2] Y. Bae, J. H. Cheon, J. Kim, J. H. Park, and D. Stehlé. HERMES: efficient ring packing using MLWE ciphertexts and application to transciphering. In CRYPTO, 2023.
[3] Y. Bae, J. H. Cheon, J. Kim, and D. Stehlé. Bootstrapping bits with CKKS. In EUROCRYPT, 2024.
[4] Y. Bae, J. Kim, D. Stehlé, and E. Suvanto. Bootstrapping small integers with CKKS. Submitted.
[5] I. Chillotti, N. Gama, M. Georgieva, and M. Izabachène. Faster fully homomorphic encryption: Bootstrapping in less than 0.1 seconds. In ASIACRYPT, 2016.
[6] I. Chillotti, M. Joye, and P. Paillier. Programmable bootstrapping enables efficient homomorphic inference of deep neural networks. In CSCML, 2021.
[7] N. Drucker, G. Moshkowich, T. Pelleg, and H. Shaul. BLEACH: Cleaning errors in discrete computations over CKKS. J. Cryptol., 2024.
[8] L. Ducas and D. Micciancio. FHEW: Bootstrapping homomorphic encryption in less than a second. In EUROCRYPT, 2015.
[9] K. Kluczniak and L. Schild. FDFB: Full domain functional bootstrapping towards practical fully homomorphic encryption. TCHES, 2022.

According to the various embodiments of the present disclosure as described above, the electronic apparatus may significantly reduce the transmission amount by transmitting only the seed and the upper bits of the integer to the server.

Meanwhile, according to an embodiment of the present disclosure, the various embodiments described above may be implemented in software including an instruction stored on a machine-readable storage medium (e.g., a computer-readable storage medium). A machine may be a device that invokes the stored instruction from a storage medium, may be operated based on the invoked instruction, and may include the electronic apparatus (e.g., electronic apparatus A) according to the disclosed embodiments. If the instruction is executed by the processor, the processor may directly perform a function corresponding to the instruction, or perform the function by using other components under control of the processor. The instruction may include codes provided or executed by a compiler or an interpreter. The machine-readable storage medium may be provided in the form of a non-transitory storage medium. Here, the term “non-transitory” refers to that the storage medium is tangible without including a signal, and does not distinguish whether data are semi-permanently or temporarily stored on the storage medium.

In addition, according to an embodiment, the methods according to the various embodiments described above may be included and provided in a computer program product. The computer program product may be traded as a commodity between a seller and a purchaser. The computer program product may be distributed in a form of the machine-readable storage medium (e.g., a compact disc read only memory (CD-ROM)), or may be distributed online through an application store (e.g., PlayStore™). In case of the online distribution, at least a part of the computer program product may be at least temporarily stored or temporarily provided on a storage medium such as the memory of a manufacturer server, an application store server, or a relay server.

In addition, according to an embodiment of the present disclosure, the various embodiments described above may be implemented in a computer-readable recording medium or a device similar thereto that uses software, hardware, or a combination of software and hardware. In some cases, the embodiments described in the specification may be implemented by a processor itself. According to software implementation, the embodiments such as the procedures and functions described in the specification may be implemented by separate software modules. Each of the software modules may perform at least one function or operation described in the specification.

Meanwhile, computer instructions for performing processing operations of the device according to the various embodiments of the present disclosure described above may be stored in a non-transitory computer-readable recording medium. The computer instructions stored in the non-transitory computer-readable recording medium may allow a specific device to perform the processing operations of the device according to the various embodiments described above in case that the computer instructions are executed by a processor of the specific device. The non-transitory computer-readable recording medium is not a medium that temporarily stores data, such as a register, a cache, or a memory, and indicates a medium that semi-permanently stores data and is readable by the device. A specific example of the non-transitory computer-readable recording medium may include a compact disk (CD), a digital versatile disk (DVD), a hard disk, a Blu-ray disk, a universal serial bus (USB), a memory card, a read-only memory (ROM), or the like.

In addition, each of the components (e.g., modules or programs) according to the various embodiments described above may include a single entity or a plurality of entities, and some of the corresponding sub-components described above may be omitted or other sub-components may be further included in the various embodiments. Alternatively or additionally, some of the components (e.g., modules or programs) may be integrated into one entity, and may perform functions performed by the respective corresponding components before being integrated in the same or similar manner. Operations performed by the modules, the programs or other components according to the various embodiments may be executed in a sequential manner, a parallel manner, an iterative manner or a heuristic manner, and at least some of the operations may be performed in a different order, omitted, or supplemented with other operations.

Although the embodiments of the present disclosure have been shown and described hereinabove, the present disclosure is not limited to the above-mentioned specific embodiments, and may be variously modified by those skilled in the art to which the present disclosure pertains without departing from the scope and spirit of the present disclosure as disclosed in the accompanying claims. These modifications should also be understood to fall within the scope and spirit of the present disclosure.

1. An electronic apparatus comprising:
a memory storing instructions;
a communication interface; and
at least one processor including processing circuitry, wherein the at least one processor is configured to
obtain a ciphertext by using a learning-with-error (LWE)-based encryption scheme or an exact Cheon-Kim-Kim-Song (CKKS)-based encryption scheme, and
control the communication interface to transmit, to a server, a seed for generating a random vector included in the ciphertext and upper bits of an integer included in the ciphertext.

2. The apparatus as claimed in claim 1, wherein the at least one processor is configured to obtain the random vector from the seed by using an extendable output function (XOF),
the extendable output function including a Secure Hash Algorithm Keccak (SHAKE) function.

3. The apparatus as claimed in claim 1, wherein the at least one processor is configured to generate a plurality of random vectors by using one seed and a counter if a plurality of ciphertexts are transmitted.

4. The apparatus as claimed in claim 1, wherein the at least one processor is configured to
compute the random vector and a secret key, and
obtain the integer based on a computation result and a plaintext corresponding to the ciphertext.

5. The apparatus as claimed in claim 1, wherein the at least one processor is configured to control the communication interface to transmit, to the server, the upper bits of the integer in a form of └(2^{\hat{p}}/Δ)·b┐,
where b indicates the integer, and \vec{p} indicates an input precision.

6. The apparatus as claimed in claim 5, wherein └(2^{\hat{p}}/Δ)·b┐ is rescaled into Δ/2^{\hat{p}} by the server and used.

7. The apparatus as claimed in claim 1, wherein the integer indicates a remainder obtained by dividing a plaintext corresponding to the ciphertext by a modulus.

8. The apparatus as claimed in claim 1, wherein the LWE-based encryption scheme includes either a Torus Fully Homomorphic Encryption (TFHE) scheme or a Fastest Homomorphic Encryption in the West (FHEW) scheme.

9. The apparatus as claimed in claim 1, wherein the seed is converted into the random vector by the server.

10. A control method of an electronic apparatus, the method comprising:
obtaining a ciphertext by using a learning-with-error (LWE)-based encryption scheme or an exact Cheon-Kim-Kim-Song (CKKS)-based encryption scheme; and
transmitting, to a server, a seed for generating a random vector included in the ciphertext and upper bits of an integer included in the ciphertext.

11. The method as claimed in claim 10, wherein in the obtaining, the random vector is obtained from the seed by using an extendable output function (XOF),
the extendable output function including a Secure Hash Algorithm Keccak (SHAKE) function.

12. The method as claimed in claim 10, wherein in the obtaining, a plurality of random vectors are generated by using one seed and a counter if a plurality of ciphertexts are transmitted.

13. The method as claimed in claim 10, wherein in the obtaining,
the random vector and a secret key are computed, and
the integer is obtained based on a computation result and a plaintext corresponding to the ciphertext.

14. The method as claimed in claim 10, wherein in the transmitting, the upper bits of the integer in a form of └(2^{\hat{p}}/Δ)·b┐ is transmitted to the server,
where b indicates the integer, and \hat{p} indicates an input precision.

15. The method as claimed in claim 14, wherein └(2^{\hat{p}}/Δ)·b┐ is rescaled into Δ/2^{\hat{p}} by the server and used.

16. The method as claimed in claim 10, wherein the integer indicates a remainder obtained by dividing a plaintext corresponding to the ciphertext by a modulus.

17. The method as claimed in claim 10, wherein the LWE-based encryption scheme includes either a Torus Fully Homomorphic Encryption (TFHE) scheme or a Fastest Homomorphic Encryption in the West (FHEW) scheme.

18. The method as claimed in claim 10, wherein the seed is converted into the random vector by the server.
